(19) United States
(12) Patent Application Publication
(10) Pub. No.: US 2008/0216618 A1
(43) Pub. Date: Sep. 11, 2008

(54) Screw Positioning Sleeve Assembly

(76) Inventor: Shiou-E CHEN, Kaohsiung County (TW)

Correspondence Address: Dr. BANGER SHIA, 102 Lindencrest Ct., Sugar Land, TX, 77479-5201, US

(21) Appl. No.: 12/124,603

(22) Filed: May 21, 2008

Related U.S. Application Data
(63) Continuation-in-part of application No. 11/671,939, filed on Feb. 6, 2007.

(51) Int. Cl. B25B 23/08

(52) U.S. Cl. 81/451

(57) ABSTRACT

A screw positioning sleeve assembly comprises an inner sleeve slideably received in an outer sleeve, so that the inner sleeve can be engaged with an ordinary tool rod or a screwdriver to screw or unscrew a screw. When screwing or unscrewing, a magnet in the outer sleeve can attract the screw. During the screwing and unscrewing process, the positioning sleeve can move towards the screw to make the magnet keep attracting the screw, thus preventing the screw from screwing or unscrewing falling off. It is noted that the rod body of the tool rod or the screwdriver can connect with the screw positioning sleeve assembly without any additional preformed structure. Therefore, the scope of applicability of the screw positioning sleeve assembly is enlarged considerably.

This application is a continuation of part of U.S. patent application Ser. No. 11/671,939, which claims the benefit of the earlier filing date of Feb. 6, 2007. Claim 1 of this application is added with the limitations of “a tool rod having a tool head” and “a screw head of the screw being engaged with the tool head while a periphery of the screw head of the screw is attracted by the magnet, and a tip of the screw being suspended from the tool head”, claims 2 to 5 of this application are the previous claims 2 to 5 of the U.S. patent application Ser. No. 11/671,939.

### BACKGROUND OF THE INVENTION

1. Field of the Invention

The present invention relates to a screw positioning sleeve assembly, and more particularly to a screw positioning sleeve assembly capable of connecting a conventional tool rod or a screwdriver for screwing or unscrewing a screw.

2. Background of the Invention

Referring to FIG. 1, it is an U.S. Pat. No. 7,124,665 (Screw positioning device for a screwdriver). An annular recess 11 is defined at the front end of an outer periphery of a tool rod 10, and the annular recess 11 has certain travel length, so that a positioning sleeve 12 with a magnet 122 disposed in a cutting groove 121 thereof can be directly engaged in the annular recess of the tool rod 10. By such arrangements, when screwing or unscrewing, the tool rod 10 cooperates with a tool head 13 to screw or unscrew a screw, the magnet 122 can attract the screw. During the screwing and unscrewing process, the positioning sleeve can move towards the screw to make the magnet keep attracting the screw, thus preventing the screw from screwing or unscrewing falling off.

Abovementioned structure is quite simple and practical, and it provides a practical tool with low cost, but after further study, the inventor of the present invention discovered that an annular recess must be preformed in the outer surface of the front end of the tool, and then the tool rod can cooperate with the positioning sleeve. Therefore, the tool rod must be particularly manufactured, and the screw positioning device cannot be applied to a conventional tool rod.

Therefore, if an ordinary tool rod without the annular recess can be fitted on the positioning sleeve, the positioning sleeve will be very easy to use and its scope of applicability will be substantially enlarged.

Referring to FIGS. 2-4, U.S. Pat. No. 6,520,509 (screw guide device with drill bit/screw bit and counter sink/drill stop means) discloses that a tool rod 10A is provided with at least one sleeve 12A at the outer periphery of the front end thereof, when the number of the sleeves 12A is more than one, the sleeves 12 are graduated in size and stacked together, each fitting within the one immediately larger. The tool rod 10A is provided at one end thereof with a central longitudinal hole 11A for insertion of a tool head 13A. Each of the sleeves 12A is provided with an elastic annular engaging portion 121A at one end thereof for engaging with its neighboring sleeve 12A, and the other end is provided with an annular stopping portion 122A protruding inwards and a cooperating interface 123A.

Referring to FIG. 4 again, when in use, a screw 14A is first manually fitted on the tool head 13A while being attracted by the tool head 13A, and then the sleeve 12A is manually extended until the sleeve 12A is nearly as long as the screw 14A, after that, the tool rod 10A and the screw 14A are aligned to a predetermined position with the interface 123A abutting against the surface to be screwed so as to drive the screw 14A into the surface by rotating the tool rod 10A. Throughout the screwing process, the sleeve 12A is maintained in a vertical position with respect to the screwing surface to prevent the screw 14A from tilting.

Such a structure design can be fitted on a front end of a common tool head 10A and can prevent the slant of the screw, but it still has the following disadvantages:

1. Since the screw 14A is engaged in the sleeve 12A, the screw 14A must be smaller than the smallest inner diameter of the sleeve 12A, therefore, only the screws 14A smaller than the inner diameter of the sleeve 12A can be used, thus limiting the application scope;

2. During the process of screwing the screw 14A, the interior of the sleeve 12A is invisible, so that when there are plural sleeves 12A and an extremely large difference between the inner diameter of the sleeve 12A and the outer diameter of the screw 14A, the deviation still exist during screwing and cannot be immediately corrected because the screw in the sleeve 12A is invisible;

3. The sleeve 12 must be manually extended and adjusted according to the length of the screw 14A, thus causing much inconvenience and wasting lots of time;

4. The sleeve 12A is only used to ensure the vertical position of the screw 14A but will be useless during unscrewing the screw 14A;

5. The tool rod 10A fitted in the sleeve 12A can only be used under the condition that the locking surface is vertical to the screw 14A, so the applicability is limited.

The present invention has arisen to mitigate and/or obviate the afore-described disadvantages.

### SUMMARY OF THE INVENTION

The primary objective of the present invention is to provide a screw positioning sleeve assembly that comprises an inner sleeve slideably received in an outer sleeve, so that the inner sleeve can be engaged with an ordinary tool rod or a screwdriver to screw or unscrew a screw. It is noted that the rod body of the tool rod or the screwdriver can be engaged in the screw positioning sleeve assembly of the present invention without any additional preformed structure. Therefore, the scope of applicability of the screw positioning sleeve assembly is enlarged considerably.

### BRIEF DESCRIPTION OF THE DRAWINGS

FIG. 1 is an exploded view of a screw positioning device for a screwdriver of the U.S. Pat. No. 7,124,665;

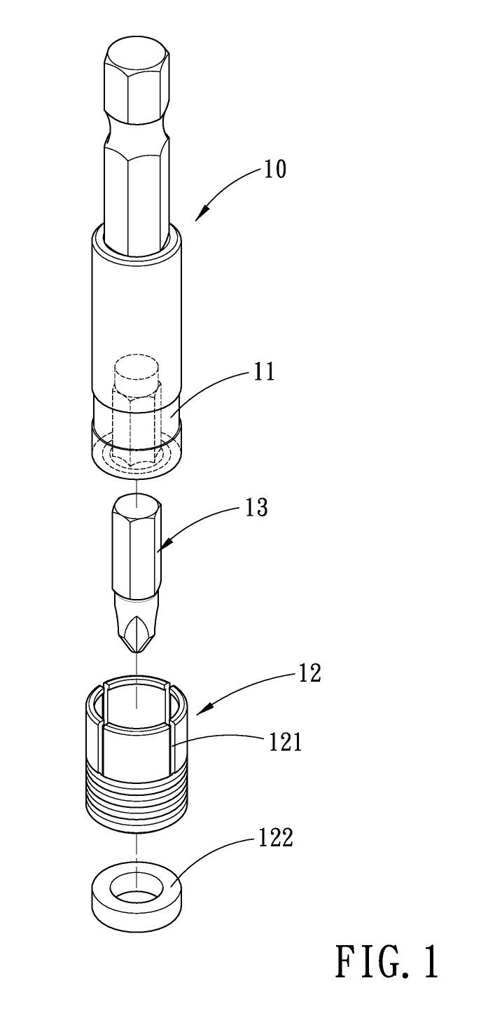

FIG. 2 is an exploded view of a tool head and sleeves of U.S. Pat. No. 6,520,509;

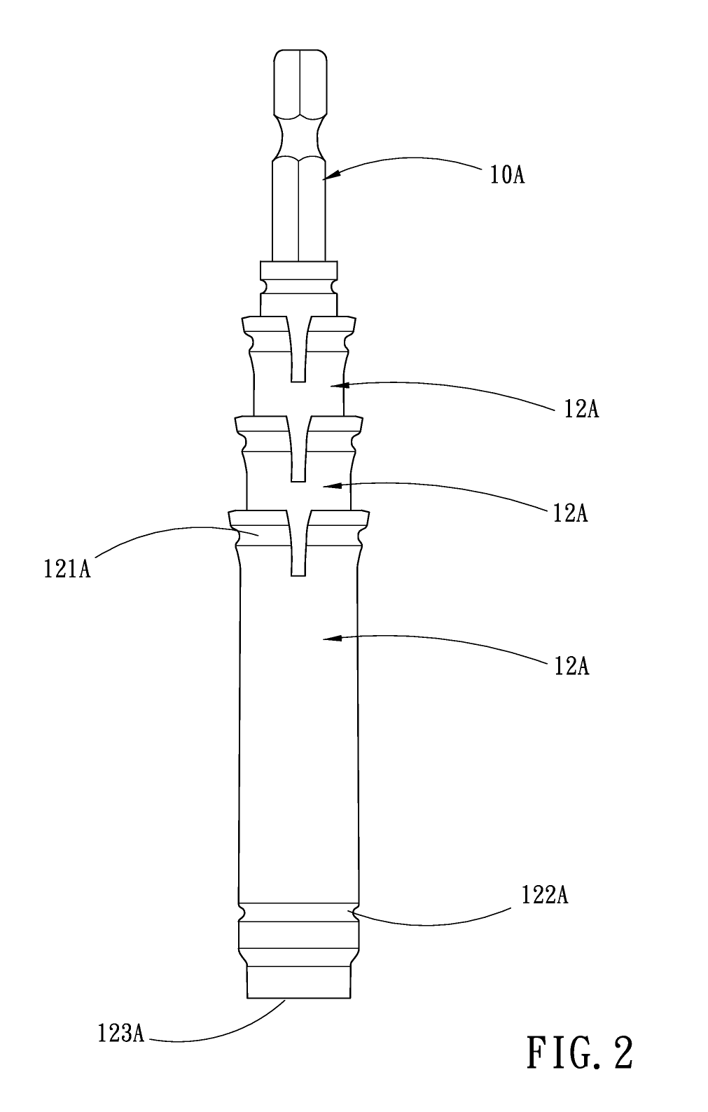

FIG. 3 is a cross-sectional view of the tool head and sleeves of U.S. Pat. No. 6,520,509;

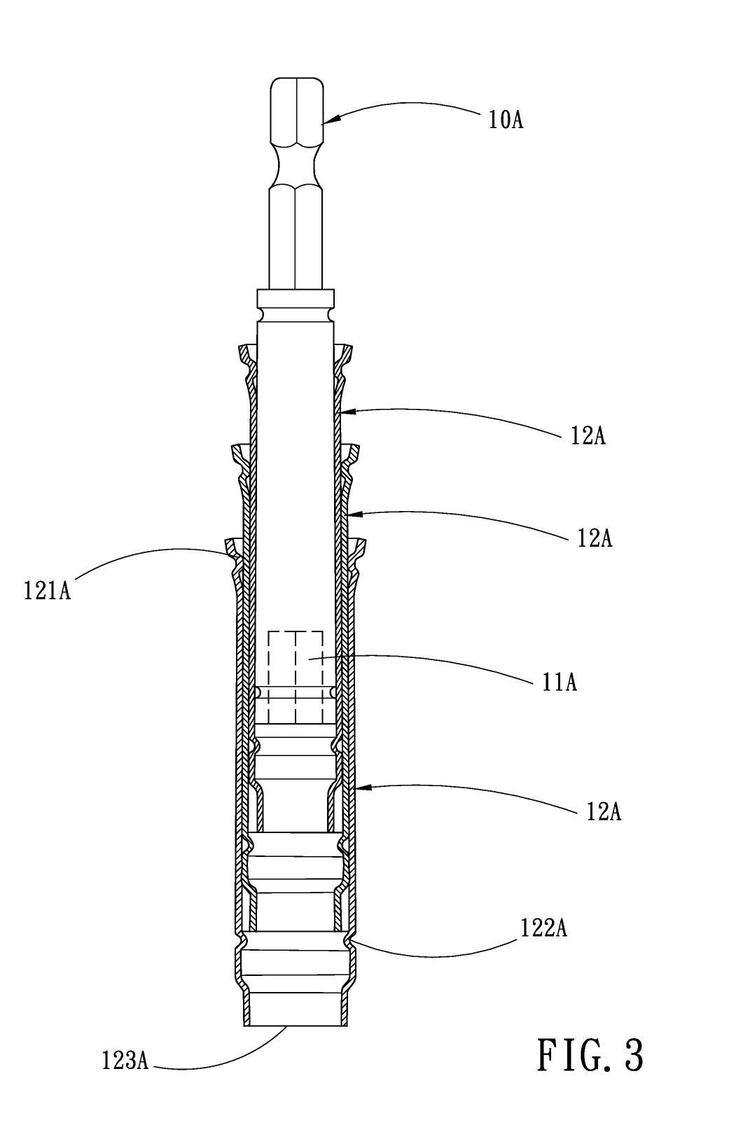

FIG. 4 is a perspective view of a tool head and sleeves in accordance with another embodiment of U.S. Pat. No. 6,520,509;

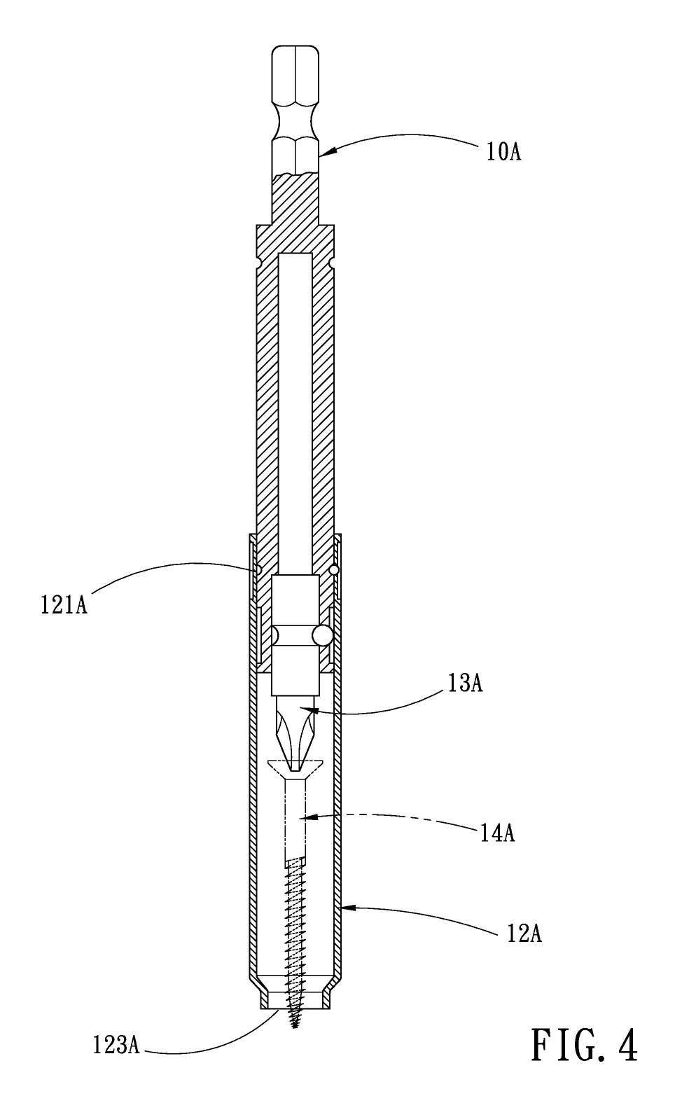

FIG. 5 is an exploded view of a screw positioning sleeve assembly in accordance with the present invention and a tool rod;

FIG. 6 is an assembly view of the screw positioning sleeve assembly in accordance with the present invention and the tool rod;

FIG. 7 is a perspective view showing that the screw positioning sleeve assembly in accordance with the present invention is connected to the tool rod;

FIG. 8 is a longitudinal sectional view of showing that the screw positioning sleeve assembly in accordance with the present invention is connected to the tool rod;

FIG. 9 is a perspective view showing that the screw positioning sleeve assembly in accordance with the present invention is screwing or unscrewing a screw;

FIG. 10 shows that the outer sleeve automatically moves along the inner tube the screw positioning sleeve assembly in accordance with the present invention under the action of magnetic force;

FIG. 11 is a schematic view showing that the screw positioning sleeve assembly in accordance with the present invention screws a different specification of screw;

FIG. 12 is a schematic view showing that the screw positioning sleeve assembly in accordance with the present invention screws a different type of screw;

FIG. 13 is a longitudinal sectional view showing that the outer sleeve of the screw positioning sleeve assembly in accordance with the present invention retracts along the inner tuber to an original predetermined position after screwing the screw;

FIG. 14 is a longitudinal sectional view showing that the screw positioning sleeve assembly in accordance with the present invention is defined with an O-shaped ring for connecting with the tool rod;

FIG. 15 is a longitudinal sectional view showing that the screw positioning sleeve assembly in accordance with the present invention is defined with a C-shaped clasp for connecting with the tool rod;

FIG. 16 is a longitudinal sectional view of FIG. 15 of showing that the screw positioning sleeve assembly in accordance with the present invention is connected to the tool rod; and

FIG. 17 is a longitudinal sectional view showing that the screw positioning sleeve assembly in accordance with the present invention is connected to a screwdriver.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

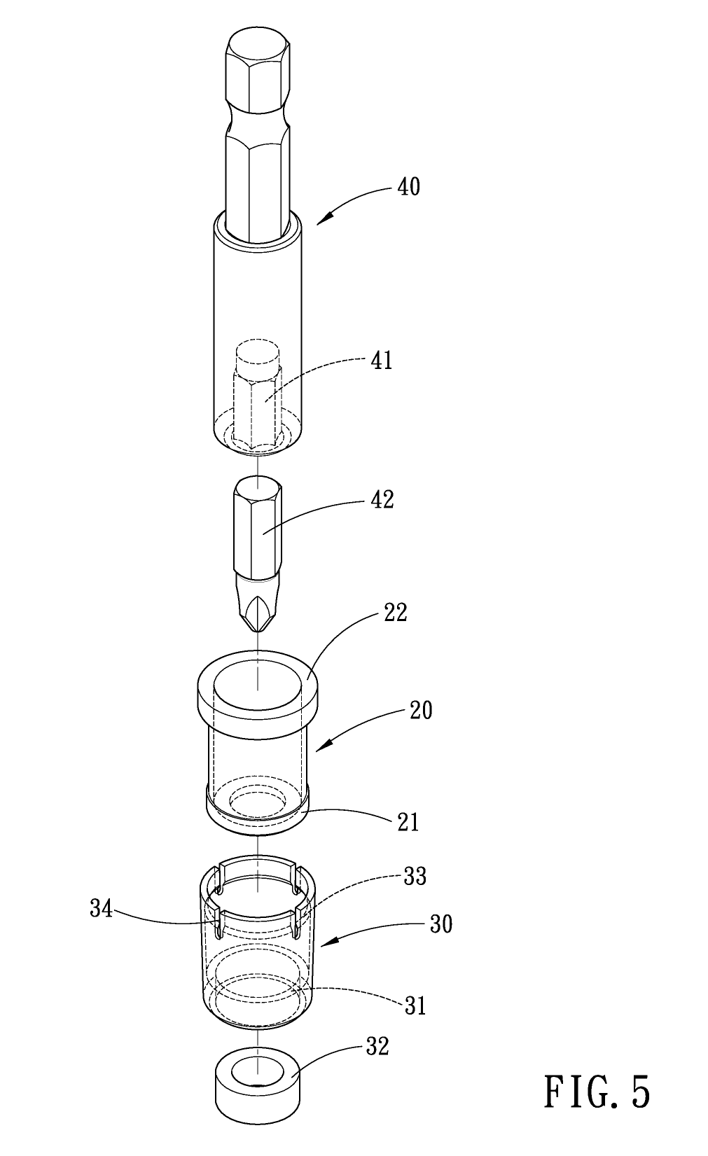

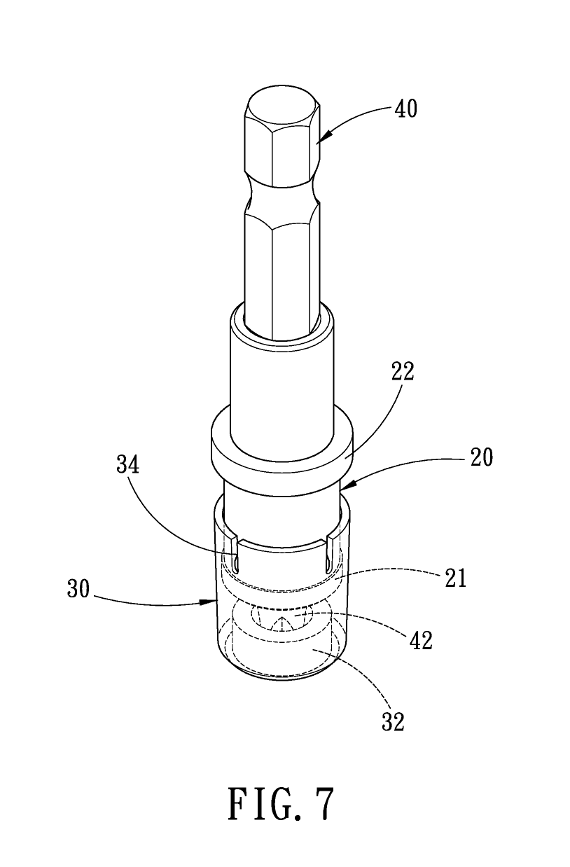

Referring to FIGS. 5-8, the present invention provides a screw positioning sleeve assembly that comprises an inner sleeve 20 slideably received in an outer sleeve 30, so that the inner sleeve can be engaged with an ordinary tool rod to screw or unscrew a screw.

The inner sleeve 20 has a front open end and a rear open end. A front flange 21 is defined on the front end of the outer surface of the inner sleeve 20, and a rear flange 22 is defined on the rear end of the outer surface of the inner sleeve 20.

The outer sleeve 30 has a front open end and a rear open end. A restricting flange 31 is defined on the front end of the inner surface of the outer sleeve 30. A magnet 32 is disposed between the front edge and the restricting flange 31 of the outer sleeve. A stopping flange 33 is defined on the rear end of the inner surface of the outer sleeve 30, and a plurality of open slots 34 is defined in the rear end of the outer sleeve. The rear end of the outer sleeve can expand by force through the open slots 34, so that the outer surface of the inner sleeve 20 can expand to fit on the outer sleeve 30. After that, the slots enable the outer sleeve 30 restore its original shape, and the stopping flange 33 and the front flange 21 mates with each other to prevent the outer sleeve 30 and the inner sleeve 20 from disconnecting from each other. Furthermore, the outer sleeve 30 can move within a fixed travel length along the inner sleeve 20. By such arrangements, the rear open end of the inner sleeve 20 can be connected to the tool rod 40 directly to rotate the screw.

Abovementioned is an illustration of the location and the structure of the respectively related subassemblies of the present invention. The structure and the subassemblies of the present invention are simply designed. A user can easily connect the inner sleeve with an ordinary tool rod to screw or unscrew a screw. In addition, the tool rod needs no any additional preformed structure. The following is the description of the operation state of the present invention:

Referring to FIGS. 5-8 again, the outer sleeve 30 of the present invention can be produced by plastic molding, so that the outer sleeve 30 has certain elasticity. By such an arrangement, when assembling the outer sleeve 30 and the inner sleeve 20, the rear end of the outer sleeve 30 can expand through the open slots 34, so that the stopping flange 33 of the outer sleeve 30 favourably passes through the front flange 21 of the inner sleeve 20. After that, the outer sleeve 30 restores its original shape, so that the stopping flange 33 and the front flange 21 are engaged with each other to prevent the outer sleeve 30 and the inner sleeve 20 disconnecting from each other.

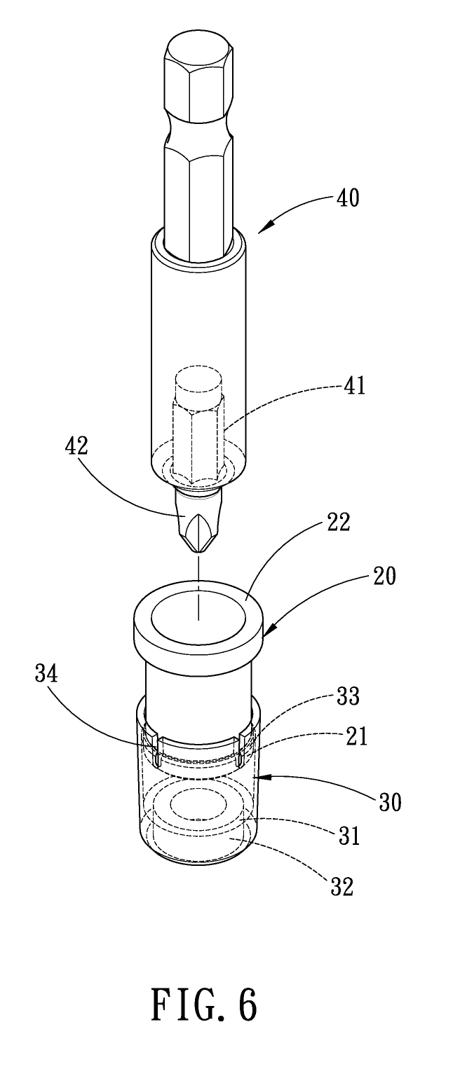

Referring to FIGS. 6-8, an insertion groove 41 is defined in the front end of the ordinary tool rod 40 for insertion of a tool head 42 to screw or unscrew a screw. The front end of the tool rod 40 is commonly cylindrical-shaped, and the rear end of the tool rod 40 can connect with a power driven tool or a hand tool (not shown). When connecting the conventional tool rod 40 to the screw positioning sleeve assembly, the user can directly insert the cylindrical-shaped rod body of the tool rod 40 into the rear open end of the inner sleeve 20 to make the tool rod 40 engage with the inner sleeve 20, so that the tool rod 40 and the screw positioning sleeve assembly are connected together.

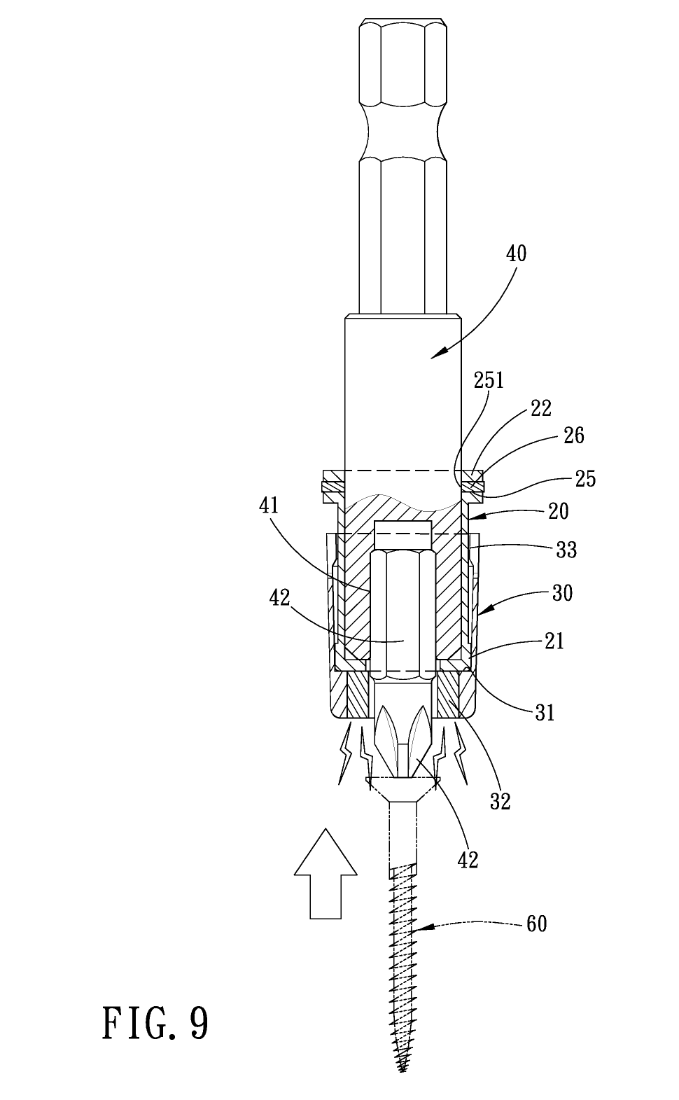

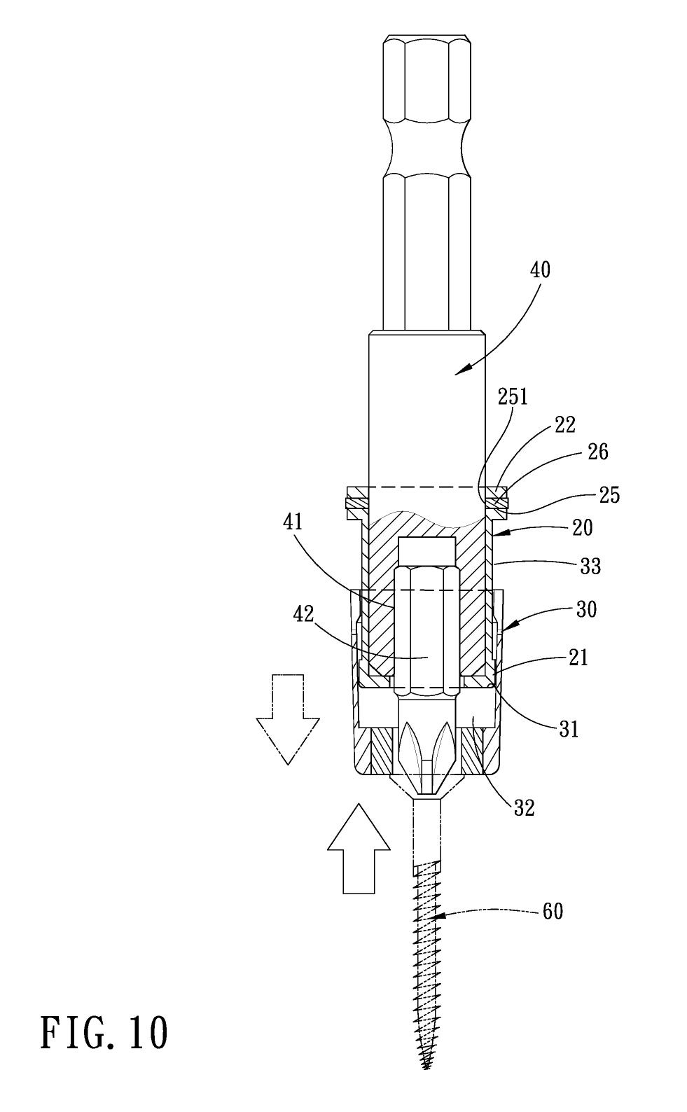

Referring to FIG. 9-10, when screwing or unscrewing a screw, the tool head 42 of the tool rod 40 is engaged with the screw 60 first, since the magnet 32 in the outer sleeve 30 is adjacent to the screw 60, the outer sleeve 30 can automatically move along the inner sleeve 20 due to magnetic force. While the screw 60 is located on the tool head 42, the magnet 32 attracts the screw head of the screw 60, so that the periphery of the end of the screw 60 is attracted by the magnet 32 while the center of the end of the screw 60 is being engaged with the tool head 42, thus ensuring that screw head of the screw 60 is assuredly positioned to the tool head 42, and the tip of the screw 60 is stably suspended from the tool head 42. During the course of screwing and unscrewing, the movement of the outer sleeve 30 makes the magnet 32 keep attracting the screw to prevent the screw from falling off.

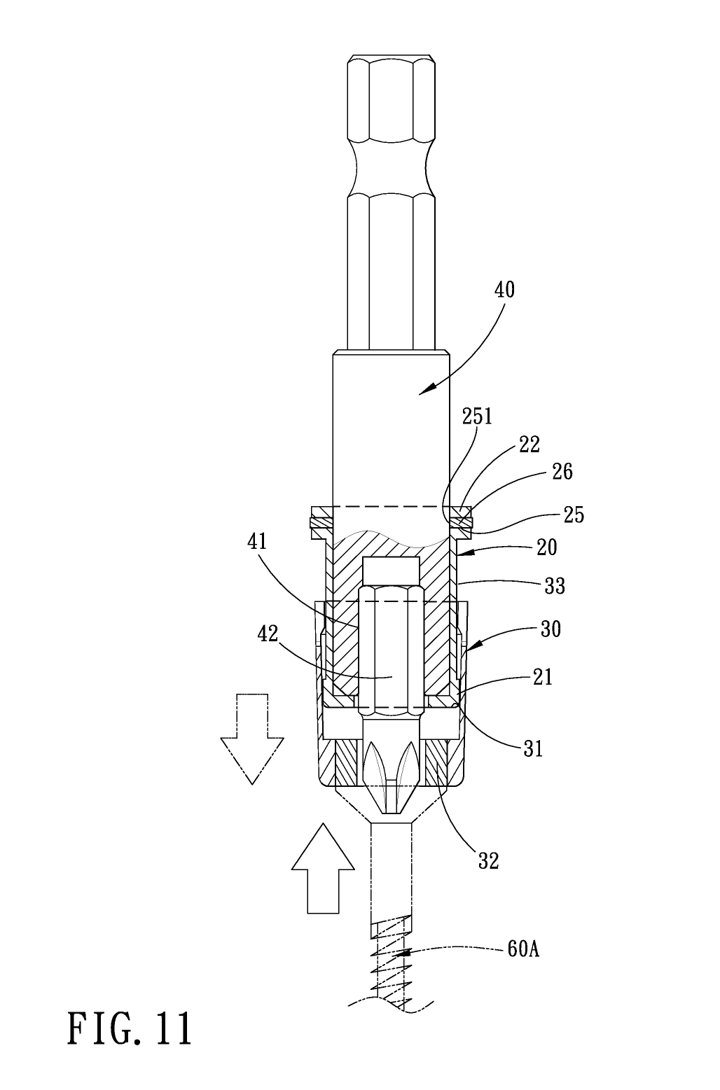

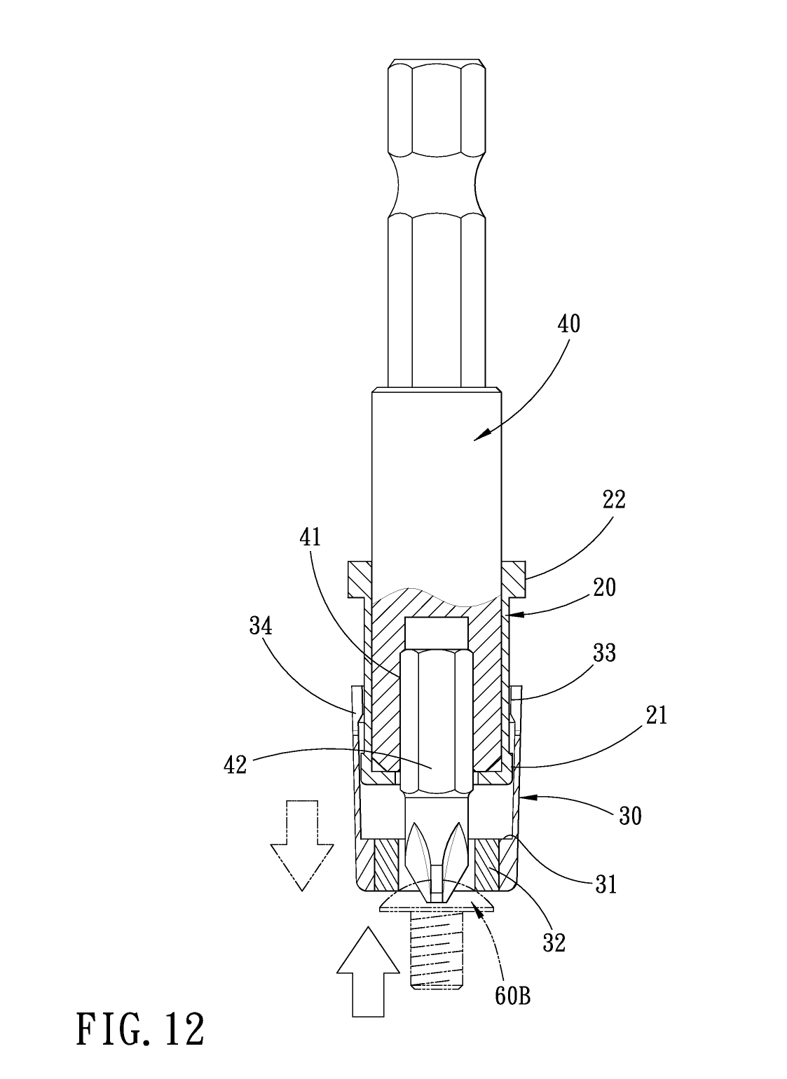

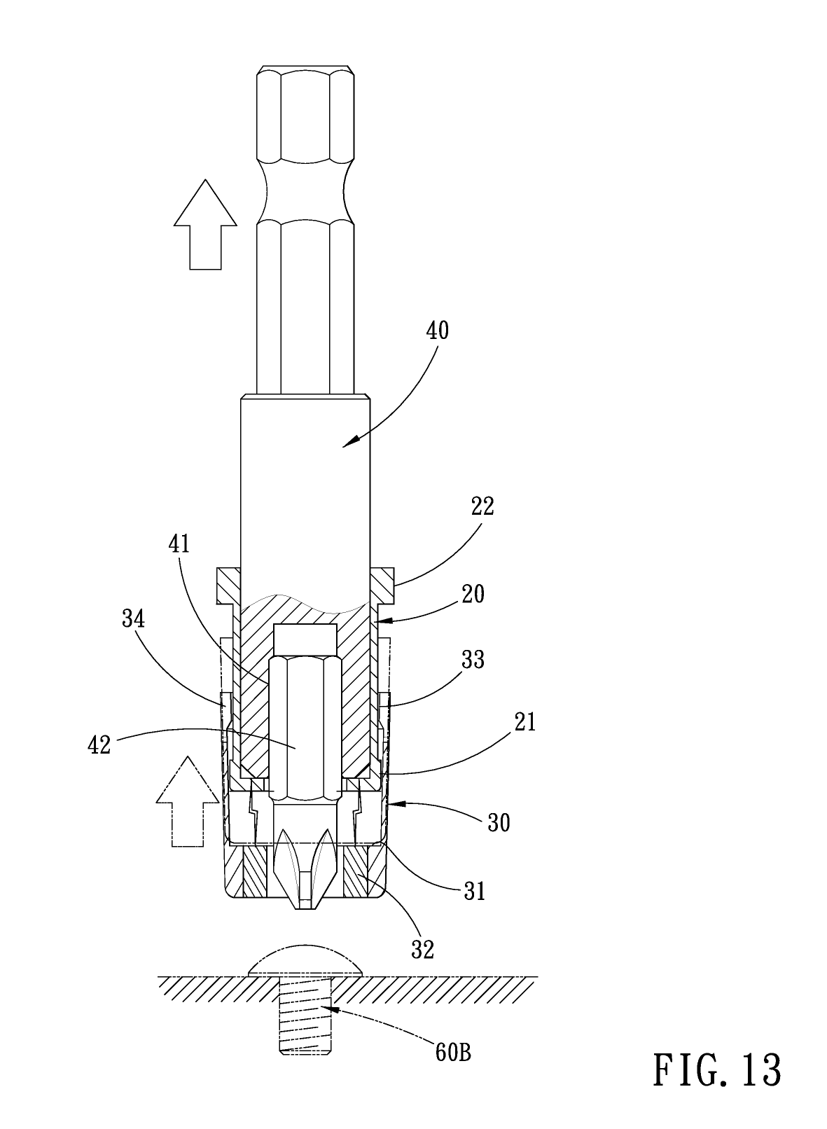

Referring to FIGS. 11-12, no matter what specification or type the screws are, the screws can all be screwed or unscrewed by the inner tube 20 cooperating with the outer tube 30. FIG. 11 shows another screw 60A which is different in specification from the screw 60 is screwed or unscrewed, and FIG. 12 shows another screw 60B which is different in type from the screw 60 is screwed or unscrewed. Moreover, because the automatic movement of the outer tube 30 is caused by magnetic force, the length or type of the tool head 42 has no influence on the movement or attraction of the outer tube 30. After the screw 60B is screwed or unscrewed, as shown in FIG. 13, as long as the screw 60B disconnects from the tool head 42, under the action of the magnetic attraction force, the outer tube 30 will retract along the inner tube 30 and return to the original predetermined position.

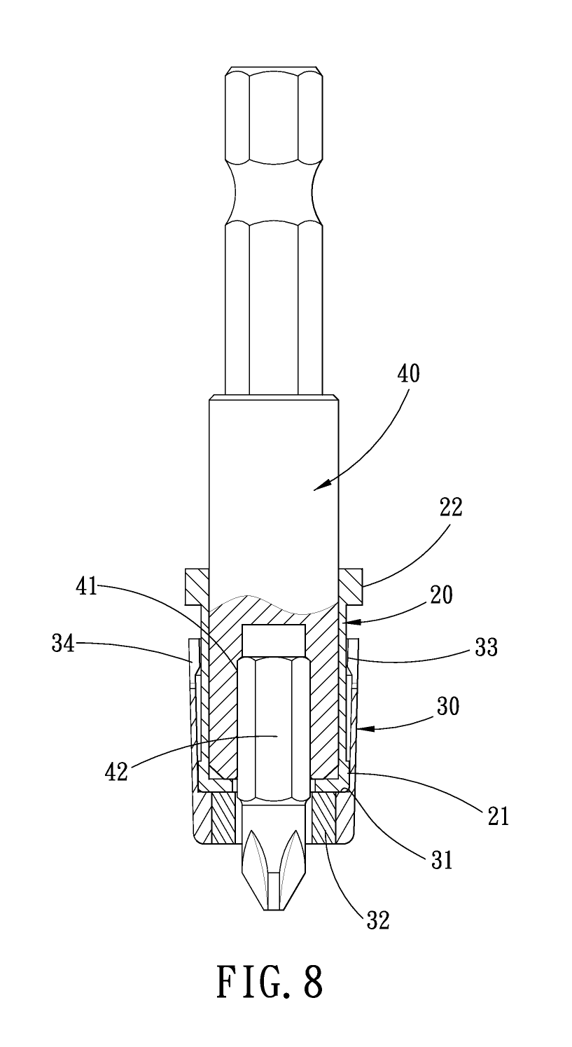

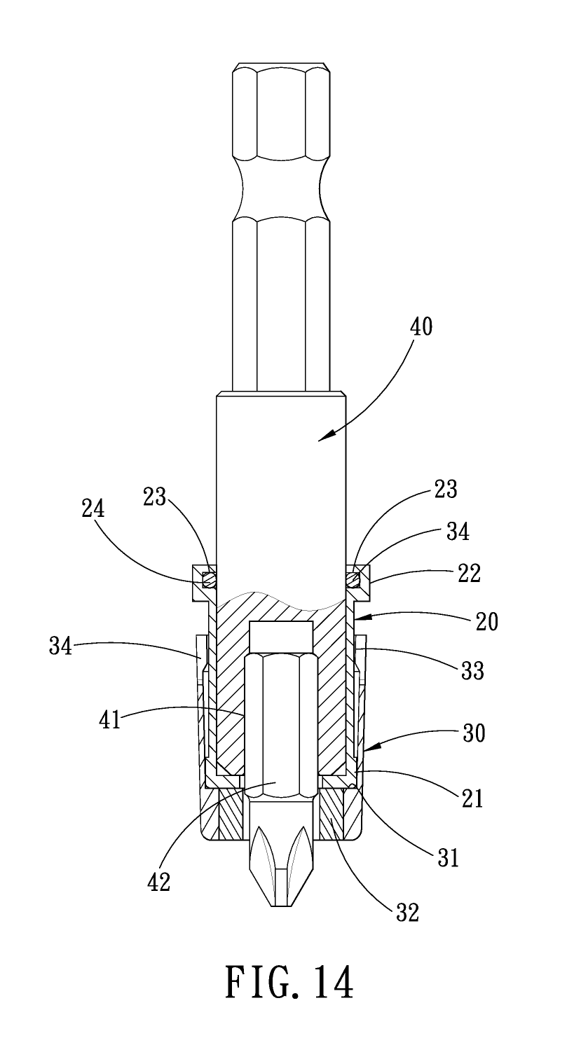

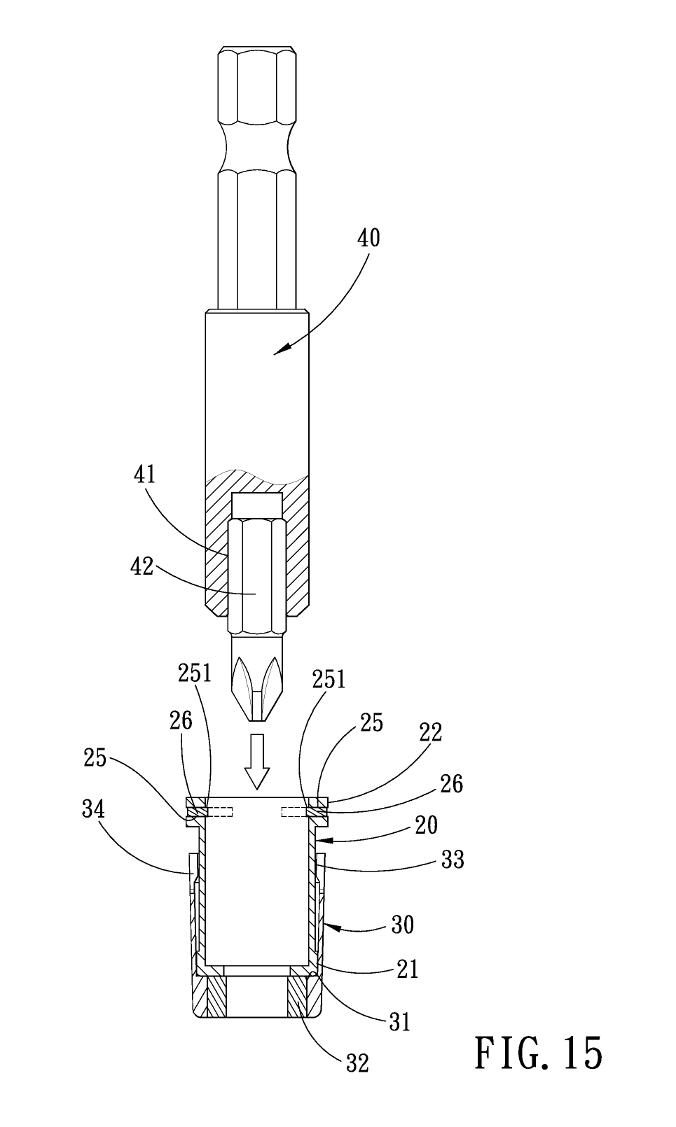

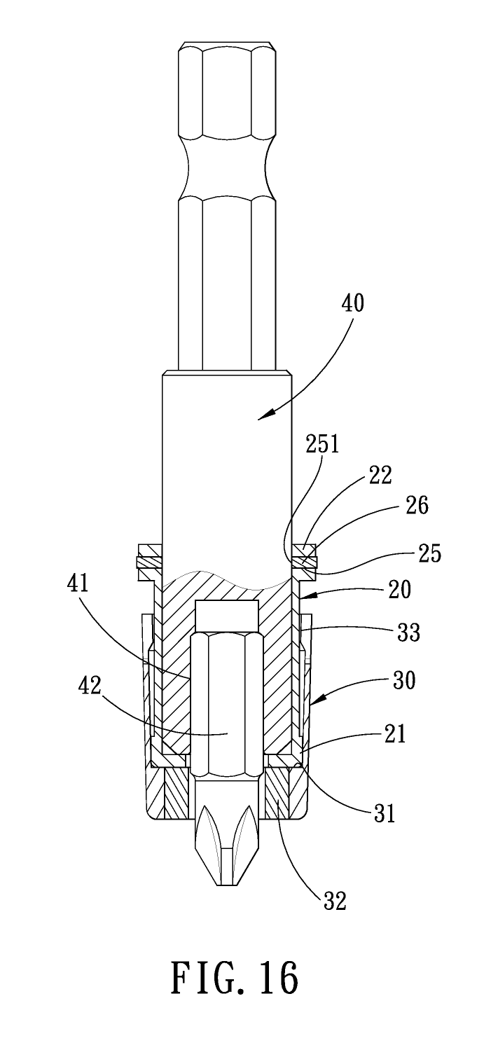

In addition, the tool rod is directly inserted into the rear open end of the inner sleeve. To prevent the tool rod from disconnecting from the inner sleeve, the following several measures can be taken. For example, as shown in FIG. 8, the size of the rear open end of the inner sleeve 20 can be designed to be equal or close to the diameter of the tool rod 40, so that the inner sleeve 20 can be engaged with the tool rod 40. Or as shown in FIG. 14, an annular recess 23 is defined in the rear end of the inner surface of the inner sleeve 20, a rubber O-shaped ring 24 is engaged in the annular recess 23, and a part of the O-shaped ring 24 protrudes out of the annular recess 23 under normal conditions, so that when inserting the tool rod 40 in the inner sleeve 20, the O-shaped ring 24 can tightly clasp an outer surface of the tool rod 40 to position the tool rod. Another measure is shown in FIGS. 15-16, an annular groove 25 is defined in the rear end of the outer surface of the inner sleeve 20, and a plurality of locking holes 251 in communication with the inner space of the inner sleeve 20 is defined in part of the annular groove 25, and a C-shaped clasp 26 is engaged in the annular groove 25 in such a manner that a part of the C-shaped clasp 26 is inserted in the inner sleeve through the locking holes 251, so that when inserting the tool rod 40 in the inner sleeve 20, the C-shaped clasp 26 can tightly clasp the outer surface of the tool rod 40 to position the tool rod.

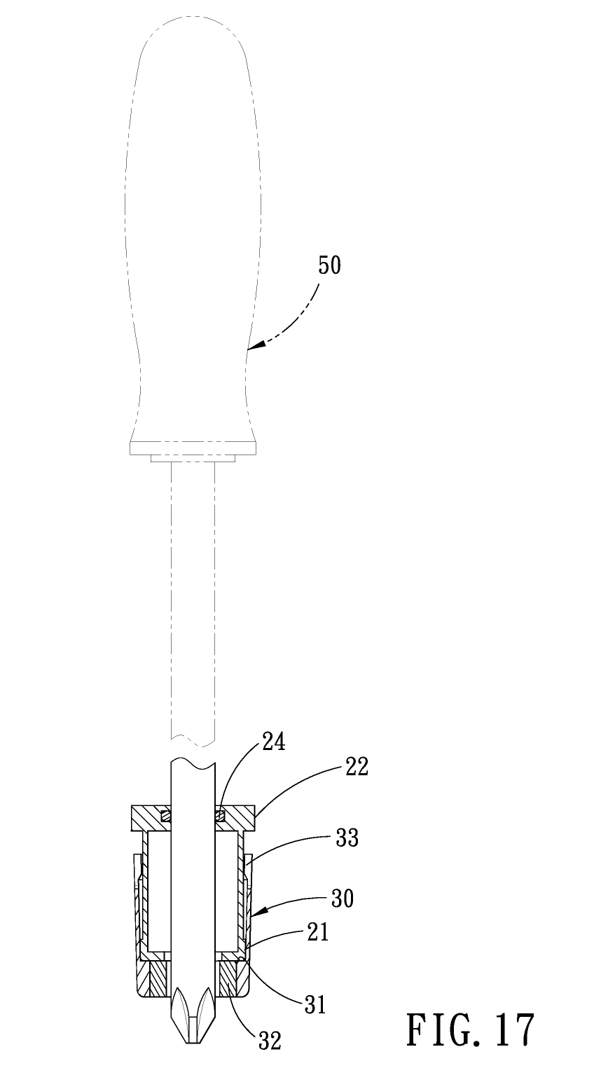

In addition, as shown in FIG. 17, a conventional screwdriver 50 can fit into the screw positioning sleeve assembly of the present invention. The rod body of the screwdriver 50 is commonly cylindrical-shaped. When connecting with the screw positioning sleeve assembly of the present invention, the user can insert the front end of the rod body of the screwdriver 50 in the rear open end of the inner sleeve 20 and can be positioned therein through the tight clasp of the O-shaped ring, so that the screwdriver 50 can cooperate with the screw positioning sleeve assembly of the present invention to screw or unscrew a screw.

Additionally, due to the manner in which the inner tube 20 cooperates with the outer tube 30 at the front end of the tool rod 40, when the screw 60 is engaged with the tool head and attracted by the magnet, the periphery of the screw 60 is not restricted, so that the present invention is suitable for use with different specification or types of screws 60, 60A, 60B, or even the special specification screws, thus having high applicability. Meanwhile, the screw 60 is exposed while being screwed, so the screwing condition of the screw is visible, and thus the adjustment and correction to the screw can be properly performed.

Further, with the magnet, the outer tube 30 can automatically extend or retract, thus avoiding the manual adjustment operation and providing much convenience.

Moreover, the present invention not only is useful during the process of screwing the screw 60, but also has the effect of engaging with and attracting the screw 60 during the unscrewing process no matter the types of the surface to be screwed. In addition, the inner tube 20 can also cooperate with the outer tube 30 to enable the screw to be slantways screwed.

To sum up, the screw positioning sleeve assembly of the present invention can be engaged with an ordinary tool rod or a screwdriver to screw or unscrew a screw. In addition, the rod body of the tool rod or the screwdriver can connect with the screw positioning sleeve assembly of the present invention needs no any additional preformed structure such as an annular recess. Therefore, the scope of applicability of the screw positioning sleeve assembly is enlarged considerably.

While we have shown and described various embodiments in accordance with the present invention, it is clear to those skilled in the art that further embodiments may be made without departing from the scope of the present invention.

What is claimed is:

1. A screw positioning sleeve assembly for connecting a tool rod having a tool head to screw or unscrew a screw, comprising:
an inner sleeve having a front open end and a rear open end, a front flange being defined on a front end of an outer surface of the inner sleeve, and a rear flange being defined on a rear end of the outer surface of the inner sleeve; and
an outer sleeve having a front open end and a rear open end, a restricting flange being defined on a front end of an inner surface of the outer sleeve, a magnet being disposed between a front edge and the restricting flange of the outer sleeve, a stopping flange being defined on a rear end of the inner surface of the outer sleeve, and a plurality of open slots being defined in the rear end of the outer sleeve, so that the rear end of the outer sleeve is expandable by force through the open slots, the rear end of the outer sleeve expands to allow the inner sleeve to fit in, after that, the slots enable the outer sleeve to restore its original shape, and the stopping flange and the front flange mates with each other to prevent the outer sleeve and the inner sleeve from disconnecting from each other, the outer sleeve being able to move within a fixed travel length along the inner sleeve, by such arrangements, the rear open end of the inner sleeve being connected to the tool rod directly to rotate the screw; and
a screw head of the screw being engaged with the tool head while a periphery of the screw head of the screw is attracted by the magnet, and a tip of the screw being suspended from the tool head.

2. The screw positioning sleeve assembly as claimed in claim 1, wherein an insertion groove is defined in a front end of the tool rod for insertion of the tool head to screw or unscrew a screw, and a rod body of the tool rod is inserted into the rear open end of the inner sleeve.

3. The screw positioning sleeve assembly as claimed in claim 1, wherein the tool rod is a screwdriver, a user can insert a front end of the screwdriver in the rear open end of the inner sleeve, so that the screwdriver cooperates with the screw positioning sleeve assembly to screw or unscrew a screw.

4. The screw positioning sleeve assembly as claimed in claim 1, wherein an annular recess is defined in a rear end of an inner surface of the inner sleeve, a rubber O-shaped ring is engaged in the annular recess, and a part of the O-shaped ring protrudes out of the annular recess, so that after the tool rod is inserted in the inner sleeve, the O-shaped ring will tightly clasp an outer surface of the tool rod to position the tool rod.

5. The screw positioning sleeve assembly as claimed in claim 1, wherein an annular groove is defined in the rear end of the outer surface of the inner sleeve, and a plurality of locking holes in communication with an inner space of the inner sleeve is defined in part of the annular groove, and a C-shaped clasp is engaged in the annular groove in such a manner that a part of the C-shaped clasp is inserted in the inner sleeve through the locking holes, so that after the tool rod is inserted in the inner sleeve, the C-shaped clasp will tightly clasp the outer surface of the tool rod to position the tool rod.
